(19) United States
(12) Patent Application Publication
(10) Pub. No.: US 2012/0162125 A1
(43) Pub. Date: Jun. 28, 2012

(54) CAPACITIVE TOUCH DISPLAY APPARATUS

(75) Inventor: SONG-LING YANG, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/152,264

(22) Filed: Jun. 3, 2011

(30) Foreign Application Priority Data
Dec. 22, 2010 (CN) 201010600686.X

(51) Int. Cl. G06F 3/044

(52) U.S. Cl. 345/174

(57) ABSTRACT

A capacitive touch display apparatus includes a screen including a number of electrodes, a controller, a current detector, a switch, a high-frequency current oscillator, and a modulator-demodulator unit. When a capacitive screen of an external device is placed in contact with the screen, the current detector determines that the high-frequency current of one or more of the electrodes changes, and the controller switches the switch to connect the high-frequency current oscillator to the modulator-demodulator unit, and transmits desired data to the modulator-demodulator unit. The modulator-demodulator unit modulates the high-frequency current generated by the high-frequency current oscillator with the desired data. The modulated high-frequency current flows to the external device via the electrodes at a contact area between the screen of the apparatus and the screen of the external device.

### BACKGROUND

1. Technical Field

The present disclosure relates to touch display apparatuses and, particularly, to a capacitive touch display apparatus with a capacitive touch screen.

2. Description of Related Art

Many electronic devices such as e-book readers or smart phones, include a capacitive touch screen. These types of devices often communicate wirelessly or through ports of the devices. However, wireless communication components may be expensive, and ports may be easily worn out or become dirty overtime and so become unreliable. Therefore, a new method of communication between these types of electronic devices is needed to solve above mentioned problems.

### BRIEF DESCRIPTION OF THE DRAWINGS

The components of the drawings are not necessarily drawn to scale, the emphasis instead being placed upon clearly illustrating the principles of a capacitive touch display apparatus. Moreover, in the drawings, like reference numerals designate corresponding parts throughout several views.

FIG. 1 is a block diagram of a capacitive touch display apparatus in accordance with an exemplary embodiment.

FIG. 2 is a schematic view showing icons of the capacitive touch display apparatus of FIG. 1 and an external device contacting the capacitive touch display apparatus of FIG. 1 in accordance with a first embodiment.

FIG. 3 is a schematic view showing the icons of the capacitive touch display apparatus of FIG. 1 and the external device in accordance with a second embodiment.

FIG. 4 is a schematic view showing the icons of the capacitive touch display apparatus of FIG. 1 and the external device in accordance with a third embodiment.

### DETAILED DESCRIPTION

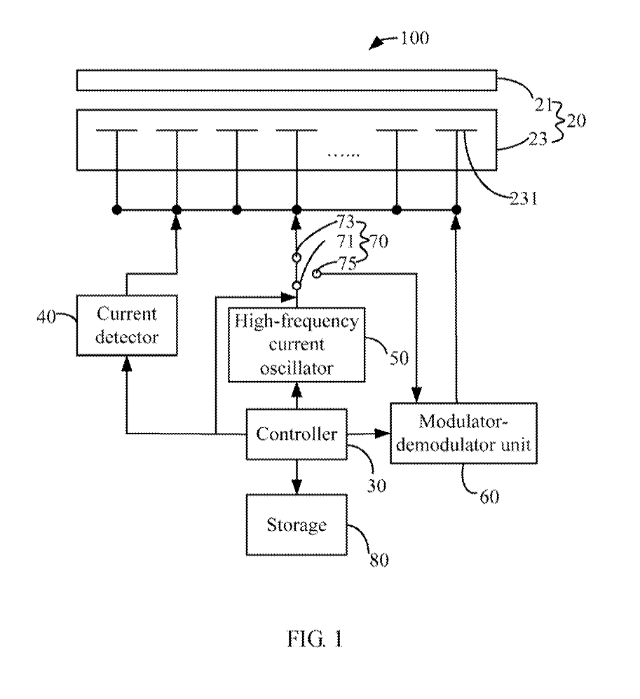

Referring to FIG. 1, an embodiment of a capacitive touch display apparatus 100 is illustrated. The apparatus 100 is an electronic device including a capacitive touch screen such as a smart phone. In this embodiment, when the apparatus 100 and another device having a capacitive screen are placed with their capacitive screens in contact with each other, the apparatus 100 can exchange data with the another device.

In this embodiment, the apparatus 100 includes a screen 20. The screen 20 includes a transparent and conductive protective layer 21 and an Indium Tin Oxide (ITO) layer 23. The ITO layer 23 is disposed below the protective layer 21 and includes a number of electrodes 231. The apparatus 100 provides high-frequency current to each electrode 231. When a touch point of the screen 20 is touched by a conductive object such as a finger or another screen similar to the present screen 20, the conductive object and one electrode 231 corresponding to the touched touch point cooperatively form a coupling capacitor, and the high-frequency current of the electrode 231 flows to ground via the coupling capacitor.

The apparatus 100 further includes a controller 30, a current detector 40, a high-frequency current oscillator 50, a modulator-demodulator unit 60, a switch 70, and a storage 80. The current detector 40 is electrically connected to the controller 30 and the electrodes 231. The current detector 40 detects changes in the high-frequency current of one or more electrodes 231. In this embodiment, the switch 70 is a monopole double throw switch. A dynamic contact point 71 of the switch 70 is connected to the controller 30 and the high-frequency current oscillator 50. A first static contact point 73 of the switch 70 is connected to the electrodes 231. A second contact point 75 is connected to the modulator-demodulator unit 60. The controller 30 is further connected to the high-frequency current oscillator 50, the modulator-demodulator unit 60, the screen 20, and the storage 80. When the apparatus 100 is not being used to exchange data with an external device 200 having a screen similar to the present screen 20, the controller 30 switches the switch 70 to connect the dynamic contact point 71 to the first static contact point 73, and the high-frequency current generated by the high-frequency current oscillator 50 flows to the electrodes 231. When the apparatus 100 is used to exchange data with the external device 200, the screen 20 of the apparatus 100 and the screen of the device 200 are placed in contact with each other. High frequency current at the area of contact will change as explained above. When the controller 30 determines that current of some of the electrodes 231 is changed, the controller 30 switches the switch 70 to connect the dynamic contact point 71 to the second static contact point 75, and the high-frequency current generated by the high-frequency current oscillator 50 flows to the modulator-demodulator unit 60. The modulator-demodulator unit 60 modulates the high-frequency current with data from the controller 30, and the modulated high-frequency current flows to the external device 200 via the electrodes 231 at the contact area.

In this embodiment, when the screen of the external device 200 is placed in contact with at least a portion of the screen 20 of the apparatus 100, electrodes (not shown) of the external device 200 and the adjacent electrodes 231 cooperatively form coupling capacitors, and the high-frequency current of the adjacent electrodes 231 changes. When an external device is placed to exchange data with the apparatus 100, the current detector 40 determines that the high-frequency current at the contact area changes, thus switches the switch 70 to connect the high-frequency current oscillator 500 to the modulator-demodulator unit 60.

In this embodiment, the controller 30 determines which area of the screen 20 is contacted according to which of the electrodes 231 undergo a change in their high-frequency current. It should be noted that only a portion of each screen need to come into contact with each other and that the portion of screen 20 not contacted can be viewed and used by the user to control data exchange. Thus, the user can operate the apparatus 100 via icons displayed on the visible area.

When the area of contact is determined, the controller 30 transmits a request signal to the modulator-demodulator unit 60. The request signal includes information of requesting the external device 200 to transmit data of icons such as icons currently displayed on the external device 200 from the external device 200 to the apparatus 100. The modulator-demodulator unit 60 modulates the high-frequency current with the request signal. The modulated high-frequency current flows to the external device 200 via the electrodes 231 at the contacted area. The external device 200 demodulates the received high-frequency current to obtain the request signal, and modulates high-frequency current generated by the external device 200 with data of the icons of the external device 200 according to the request signal. The modulated high-frequency current of the external device 200 flows to the apparatus 100. The modulator-demodulator unit 60 demodulates the modulated high-frequency current from the external device 200 to obtain the icons of the external device 200.

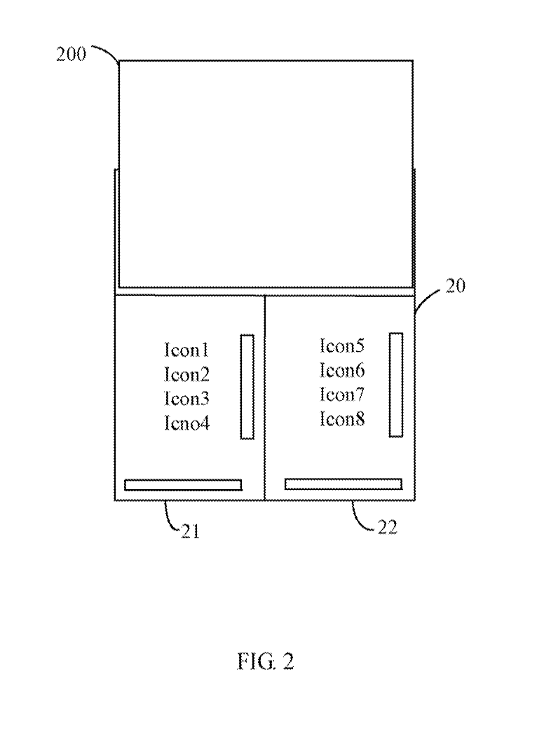

Referring to FIG. 2, in a first embodiment, when the icons of the external device 200 is obtained, the controller 30 divides a visible portion of the screen 20 into a first region 21 to display the icons of the external device 200 and a second region 22 to display icons of the apparatus 100. When one icon in the first region 21 is selected, the controller 30 transmits a control signal including the selected icon to the external device 200 to direct the external device 200 to execute a corresponding function. When one icon in the first region 21 is dragged out of the first region 21, the controller 30 transmits a copy signal including the dragged icon to the external device 200 to direct the external device 200 to transmit data corresponding to the dragged icon to the apparatus 100. When one icon in the second region 22 is dragged into the first region 21, the controller 30 transmits data corresponding to the dragged icon from the apparatus 100 to the external device 200. In the first embodiment, the controller 30 may further display scroll bars in the first region 21 and the second region 22 to scroll through the icons in the visible portion.

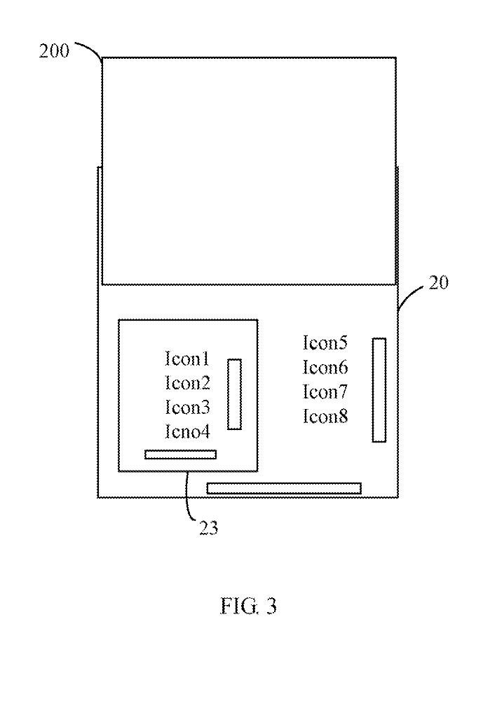

Referring to FIG. 3, in a second embodiment, when the icons of the external device 200 is obtained, the controller 30 displays a user interface 23 on a visible portion of the screen 20, and displays the icons of the external device 200 in the user interface 22. The user interface 23 may be fixed in the visible portion, or a floating interface which can be moved via applying sliding touch on the screen 20. The controller 30 further displays the icons of the apparatus 100 in the visible portion and out of the user interface 23 if the user interface 23 is fixed in the visible portion, or displays icons of the apparatus 100 in the visible portion if the user interface 23 is the floating interface. In the second embodiment, when one icon in the user interface 23 is selected, the controller 30 transmits a control signal including the selected icon to the external device 200 to direct the external device 200 to execute a corresponding function. When one icon in the user interface 23 is dragged out of the user interface 23, the controller 30 transmits a copy signal including the dragged icon to the external device 200 to direct the external device 200 to transmit data corresponding to the dragged icon to the apparatus 100. When one icon out of the user interface 23 is dragged into the user interface 23, the controller 30 transmits data corresponding to the dragged icon from the apparatus 100 to the external device 200. In the second embodiment, the controller 30 can further display scroll bars in the user interface 23 and out of the user interface 23 to scroll the icons in the user interface 23 and out of the user interface 23.

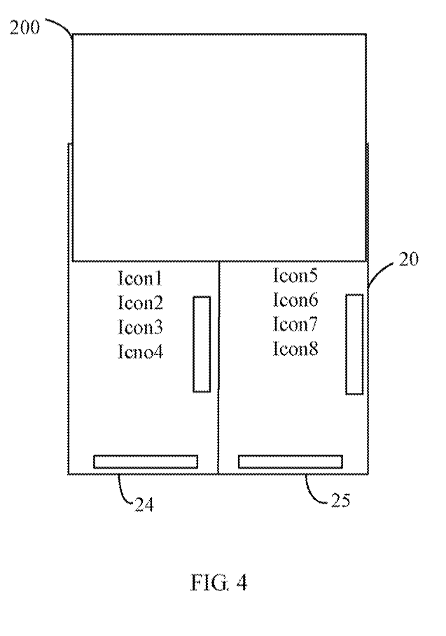

Referring to FIG. 4, in a third embodiment, when the icons of the external device 200 is obtained, the controller 30 divides the whole screen 20 into a first portion 24 to display the icons of the external device 200 and a second portion 25 to display the icons of the apparatus 100. The controller 30 further displays scroll bars in the first portion 24 and the second portion 25 to scroll through the icons in the first portion 24 and the second portion 25. When one icon in the first portion 24 is dragged into the second portion 25, the controller 30 transmits a copy signal including the dragged icon to the external device 200 to direct the external device 200 to transmit data corresponding to the dragged icon to the apparatus 100. When one icon in the second portion 25 is dragged into the first portion 24, the controller transmits data corresponding to the dragged icon to the external device 200.

In an alternative embodiment, a portion of the screen 20 or the whole screen 20 can be contacted with the screen of the external device 200. When the controller 30 determines that the screen 20 is contacted with another screen, the controller 30 transmits data of a document currently run by the apparatus 100 to the external device 200, or transmits a request signal to request the external device 200 to transmit data of a document currently run by the external device 200 to the apparatus 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A capacitive touch display apparatus comprising:
a screen comprising a plurality of electrodes;
a controller;
a switch controlled by the controller;
a high-frequency current oscillator capable of generating high-frequency current, the high-frequency current generated by the high-frequency current oscillator flowing to the plurality of the electrodes when the controller switches the switch to connect the high-frequency oscillator to the plurality of the electrodes;
a modulator-demodulator unit, the high-frequency current generated by the high-frequency current oscillator flowing to the modulator-demodulator unit when the controller switches the switch to connect the high-frequency oscillator to the modulator-demodulator unit, the high-frequency current modulated by the modulator-demodulator unit flowing to the plurality of the electrodes; and
a current detector to detect changes in the high-frequency current of one or more of the plurality of the electrodes;
wherein, when a capacitive screen of an external device is placed in contact with the screen, the current detector determines that the high-frequency current of one or more of the electrodes changes, the controller switches the switch to connect the high-frequency current oscillator to the modulator-demodulator unit, and transmits desired data to the modulator-demodulator unit, the modulator-demodulator unit modulates the high-frequency current generated by the high-frequency current oscillator with the desired data, the modulated high-frequency current flows to the external device via the electrodes at a contact area between the screen and the capacitive screen of the external device.

2. The capacitive touch display apparatus as described in claim 1, wherein the switch is a monopole double throw switch, the switch comprises a dynamic contact point, a first static contact point, and a second static contact point, the dynamic contact point is connected to the controller and the high-frequency oscillator, the first static contact point is connected to the plurality of the electrodes, and the second static contact point is connected to the modulator-demodulator unit.

3. The capacitive touch display apparatus as described in claim 1, wherein the desired data is a request signal, the request signal comprises information of requesting the external device to transmit data needed by the capacitive touch display apparatus from the external device to the capacitive touch display apparatus, the modulator-demodulator unit is to demodulate high-frequency current from the external device via the electrodes at the contact area.

4. The capacitive touch display apparatus as described in claim 3, wherein the controller is further to determine which portion of the screen is contacted with the external device according to the electrodes undergo a change in their high-frequency current, when the modulated high-frequency current comprising data of icons of the external device is transmitted from the external device to the capacitive touch display apparatus, the modulator-demodulator unit demodulates the modulated high-frequency current from the external device to obtain the icons of the external device, and the controller is to divide a visible portion of the screen into a first region to display the icons of the external device and a second region to display icons of the capacitive touch display apparatus, and further transmit a control signal comprising a selected one of the icons displayed in the first region to the external device to direct the external device to execute a corresponding function.

5. The capacitive touch display apparatus as described in claim 4, wherein the controller is further to determine which of the icons in the first region is dragged into the second region, and transmit a copy signal comprising the dragged icon to the external device to direct the external device to transmit data corresponding to the dragged icon to the capacitive touch display apparatus.

6. The capacitive touch display apparatus as described in claim 4, wherein the controller is further to determine which of the icons in the second region is dragged into the first region, and transmit data corresponding to the dragged icon to the external device.

7. The capacitive touch display apparatus as described in claim 4, wherein the controller is further to display scroll bars in the visible portion of the screen to scroll through the icons in the visible portion.

8. The capacitive touch display apparatus as described in claim 3, wherein the controller is further to determine which portion of the screen is contacted with the external device according to the electrodes undergo a change in their high-frequency current, when the modulated high-frequency current comprising data of icons of the external device is transmitted from the external device to the capacitive touch display apparatus, the modulator-demodulator unit demodulates the modulated high-frequency current from the external device to obtain the icons of the external device, and the controller is to display a user interface in a visible portion of the screen to display the icons of the external device in the user interface, the controller is further to transmit a control signal comprising a selected one of the icons in the user interface to the external device to direct the external device to execute a corresponding function.

9. The capacitive touch display apparatus as described in claim 8, wherein the user interface is fixed in the visible portion, and the controller is further to display icons of the capacitive touch display apparatus in the visible portion and out of the user interface.

10. The capacitive touch display apparatus as described in claim 8, wherein the user interface is a floating interface capable of being moved via applying sliding touch on the screen, and the controller is further to display icons of the capacitive touch display apparatus in the visible portion.

11. The capacitive touch display apparatus as described in claim 8, wherein the controller is further to determine which of the icons in the user interface is dragged out of the user interface, and transmit a copy signal comprising the dragged icon to direct the external device to transmit data corresponding to the dragged icon to the capacitive touch display apparatus.

12. The capacitive touch display apparatus as described in claim 9, wherein the controller is further to determine which of the icons of the capacitive touch display apparatus is dragged into the user interface, and transmit data corresponding to the dragged icon to the external device.

13. The capacitive touch display apparatus as described in claim 10, wherein the controller is further to determine which of the icons of the capacitive touch display apparatus is dragged into the user interface, and transmit data corresponding to the dragged icon to the external device

14. The capacitive touch display apparatus as described in claim 8, wherein the controller is further to display scroll bars in the user interface to scroll through the icons in the user interface.

15. The capacitive touch display apparatus as described in claim 9, wherein the controller is further to display scroll bars out of the user interface to scroll through the icons out of the user interface.

16. The capacitive touch display apparatus as described in claim 10, wherein the controller is further to display scroll bars out of the user interface to scroll through the icons out of the user interface.

17. The capacitive touch display apparatus as described in claim 3, wherein when the modulated high-frequency current comprising data of icons of the external device is transmitted from the external device to the capacitive touch display apparatus, the modulator-demodulator unit demodulates the modulated high-frequency current from the external device to obtain the icons of the external device, and the controller is to divide the whole screen into a first portion to display the icons of the external device and a second portion to display icons of the capacitive touch display apparatus, and display scroll bars in the first portion and the second portion to scroll through the icons in the first portion and the second portion.

18. The capacitive touch display apparatus as described in clam 17, wherein the controller is further to determine which of the icons in the first portion is dragged into the second portion, and transmit a copy signal comprising the dragged icon to direct the external device to transmit data corresponding to the dragged icon to the capacitive touch display apparatus.

19. The capacitive touch display apparatus as described in claim 17, wherein the controller is further to determine which of the icons in the second portion is dragged into the first portion, and transmit data corresponding to the dragged icon to the external device.

20. The capacitive touch display apparatus as described in claim 1, wherein the desired data is a document currently run by the capacitive touch display apparatus.
